(19) United States
(12) Patent Application Publication
(10) Pub. No.: US 2025/0048290 A1
(43) Pub. Date: Feb. 6, 2025

(54) MEASUREMENT DEVICE AND PTP TIME ERROR INSERTION METHOD THEREOF

(71) Applicant: ANRITSU CORPORATION, Kanagawa (JP)

(72) Inventors: Koji FUKAZAWA, Kanagawa (JP); Hiroyuki TANIKAGE, Kanagawa (JP)

(21) Appl. No.: 18/783,607

(22) Filed: Jul. 25, 2024

(30) Foreign Application Priority Data
Aug. 2, 2023 (JP) 2023-126253

(51) Int. Cl. H04W 56/00; H04J 3/06; H04W 24/06

(52) U.S. Cl. CPC H04W 56/003; H04J 3/0667; H04W 24/06

(57) ABSTRACT

There are provided an Ethernet unit that performs transmission and reception of a packet with an O-RU, a time generation unit that generates a base time of a measurement device, a transmission time error insertion unit that inserts an error in a time generated by the time generation unit in a case of inserting a PTP error, and a reception time error insertion unit that inserts an error in a time which is notified by the Ethernet unit in a case of inserting a PTP error, in which the transmission time error insertion unit and the reception time error insertion unit add an error amount while gradually increasing the error amount to an offset value in a case where an offset-attached error addition test is performed, and perform the error addition test in a case where the error amount reaches the offset value.

### TECHNICAL FIELD

The present invention relates to a measurement device that simulates an O-RAN Distributed Unit (O-DU) of an Open-Radio Access Network (O-RAN).

### BACKGROUND ART

In a wireless communication network, as an architecture of a Radio Access Network (RAN) including a base station or the like that is located between a core network and a terminal to perform control on a wireless layer, there is a Centralized Radio Access Network (C-RAN), in which a plurality of wireless units are extended from a baseband processing unit of a base station device that is installed in an aggregated manner and the plurality of wireless units are connected to each other by an optical fiber or the like.

In the C-RAN, there is insufficient standardization for an interface between the baseband processing unit and the wireless units and there are many regions that are individually specified by each vendor, so that it is difficult to realize interconnection between the baseband processing unit and the wireless units of different vendors.

In order to solve such a problem, an O-RAN fronthaul specification has been formulated, and the radio access network is functionally divided into the O-DU as the baseband processing unit and an O-RAN Radio Unit (O-RU) as a wireless unit, and each function is defined.

In the O-RAN fronthaul specification, a Control, User, and Synchronization Plane (C/U/S-Plane) specification that defines details of a device operation and a Management Plane (M-Plane) specification are formulated.

Between the O-DU and the O-RU, high synchronization accuracy is required in order to realize cooperative control based on synchronization between O-RUs, such as Carrier Aggregation (CA) and Multiple Input Multiple Output (MIMO), using the plurality of O-RUS.

In the O-RAN fronthaul specification, as the S-Plane, Precision Time Protocol (PTP) and Synchronous Ethernet (SyncE, registered trademark), which are protocols for realizing high synchronization accuracy on an O-RU side by synchronizing with a clock on a high-performance O-DU side, are supported.

Patent Document 1 discloses a communication system configured such that each of two or more master devices transmits and receives a main signal to and from one slave device using a communication protocol including synchronization information, in which each of the master devices and the slave device transmit and receive the main signal to and from each other using the communication protocol including the synchronization information, the slave device calculates synchronization difference information by comparing the synchronization information of each of the master devices with time information of a timer that determines time information of the slave device, the timer confirms the time information using the synchronization difference information calculated from the synchronization information of the master device selected as a synchronization source, holds the synchronization difference information from the synchronization information of the master device which is not selected as the synchronization source, selects one master device as a time synchronization source of the slave device, enables establishment of communication between the master device which is not selected as the time synchronization source and the slave device, and reduces a time required for switching the master device which is the time synchronization source of the slave device.

### RELATED ART DOCUMENT

### Patent Document

[Patent Document 1] WO2022/070351

### DISCLOSURE OF THE INVENTION

### Problem that the Invention is to Solve

In a measurement device that simulates an O-DU, a PTP time error insertion function is required, which has a form of adding a time waveform of an offset-attached sine shape to a PTP time in order to execute a resistance performance test with respect to an error of an O-RU, based on the standard of an O-RAN (O-RAN.WG4.CONF.0-R003-v07.00 Sec.3.3.3).

However, in a case where an error is rapidly inserted at the PTP time in order to insert an error of an offset, PTP time synchronization is deviated, so that an error insertion test cannot be performed.

In addition, in the PTP time error insertion, an error should be inserted only at a time used in the PTP instead of real time recognized by the measurement device.

Therefore, an object of the present invention is to provide a measurement device capable of realizing a PTP time error insertion function PTP time without causing synchronization deviation.

### Means for Solving the Problem

According to the present invention, there is provided a measurement device that simulates an O-RAN Distributed Unit (O-DU) of an Open-Radio Access Network (O-RAN), the measurement device including an Ethernet unit that performs transmission and reception of a packet with an O-RAN Radio Unit (O-RU) via a network conforming to a standard of Ethernet, a time generation unit that generates a base time of the measurement device, a transmission time error insertion unit that inserts an error in a time generated by the time generation unit, and notifies the Ethernet unit of the time in which the error is inserted, and a reception time error insertion unit that inserts, in a case where the Ethernet unit receives the packet from the O-RU, an error in a time which is notified by the Ethernet unit and at which the packet is received, in which the transmission time error insertion unit and the reception time error insertion unit add an error amount while gradually increasing the error amount to a predetermined offset value in a case where an error addition test is performed by setting an offset value, and perform the error addition test in a case where the error amount reaches the offset value.

With this configuration, the error amount is gradually increased and added to the offset value in a case where the offset-attached error addition test is performed, and the error addition test is performed in a case where the error amount reaches the offset value. Therefore, a PTP time error insertion function can be realized without causing a PTP time synchronization deviation.

In addition, in the measurement device according to the present invention, the transmission time error insertion unit and the reception time error insertion unit increase a predetermined error amount for each predetermined period, and increase the error amount to the offset value.

With this configuration, the error amount is increased by the predetermined error amount for each predetermined period, and the error amount is increased to the offset value. Therefore, a PTP time error insertion function can be realized without causing a PTP time synchronization deviation.

In addition, in the measurement device according to the present invention, the transmission time error insertion unit and the reception time error insertion unit gradually reduce the error amount from the offset value after the error addition test is terminated.

With this configuration, the error amount is gradually lowered from the offset value after the error addition test is terminated. Therefore, a subsequent test can be performed without causing a PTP time synchronization deviation.

In addition, according to the present invention, there is provided a PTP time error insertion method of a measurement device that simulates an O-DU of an O-RAN, the PTP time error insertion method including a step of gradually adding and increasing an error amount to an offset value in a case of performing an offset-attached error addition test, and a step of performing the error addition test in a case where the error amount reaches the offset value.

With this configuration, the error amount is gradually increased and added to the offset value in a case where the offset-attached error addition test is performed, and the error addition test is performed in a case where the error amount reaches the offset value. Therefore, a PTP time error insertion function can be realized without causing a PTP time synchronization deviation.

In addition, in the PTP time error insertion method according to the present invention, the step of gradually adding and increasing the error amount to the offset value includes gradually increasing a predetermined error amount for each predetermined period, and increasing the error amount to the offset value.

In addition, in the PTP time error insertion method according to the present invention, the error amount is gradually reduced from the offset value after the error addition test is terminated.

### Advantage of the Invention

The present invention can provide a measurement device capable of realizing a PTP time error insertion function without causing PTP time synchronization deviation.

### BRIEF DESCRIPTION OF THE DRAWINGS

FIG. 1 is a block diagram of a measurement device according to an embodiment of the present invention.

FIG. 2 is a diagram showing an example of a time error insertion button of the measurement device according to the embodiment of the present invention.

FIG. 3 is a diagram showing a change in a time error inserted by the measurement device according to the embodiment of the present invention.

### BEST MODE FOR CARRYING OUT THE INVENTION

Hereinafter, a measurement device according to an embodiment of the present invention will be described in detail with reference to the drawings.

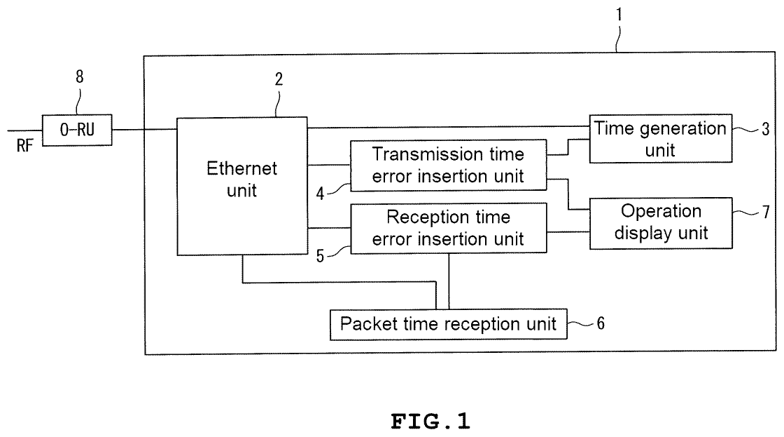

In FIG. 1, a measurement device 1 according to the embodiment of the present invention is composed of a computer unit including a Central Processing Unit (CPU), a Random Access Memory (RAM), a Read Only Memory (ROM), a flash memory, a hard disk device, an input port, and an output port.

In the computer unit, for example, the CPU executes an Operating System (OS) stored in the hard disk device, so that the CPU can control devices connected to the input port and the output port.

The measurement device 1 is composed of an Ethernet unit 2, a time generation unit 3, a transmission time error insertion unit 4, a reception time error insertion unit 5, a packet time reception unit 6, and an operation display unit 7.

The Ethernet unit 2 performs transmission and reception of a packet to and from an O-RU 8 via a network conforming to an Ethernet standard. The Ethernet unit 2 notifies the packet time reception unit 6 of a time at which the packet is transmitted to the O-RU 8. The Ethernet unit 2 notifies the reception time error insertion unit 5 of a time at which the packet is received from the O-RU 8.

The time generation unit 3 generates a base time to be used as a transmission time and a reception time by the Ethernet unit 2. The time generation unit 3 supplies the generated time to the Ethernet unit 2 and the transmission time error insertion unit 4.

In a case of PTP error insertion, the transmission time error insertion unit 4 inserts an error in the time generated by the time generation unit 3 and notifies the Ethernet unit 2 of a time in which the error is inserted.

In a case of the PTP error insertion, the reception time error insertion unit 5 inserts an error in the time notified from the Ethernet unit 2, and notifies the packet time reception unit 6 of the time in which the error is inserted.

The packet time reception unit 6 receives a packet transmission time from the Ethernet unit 2, and receives a reception time in which the error is inserted from the reception time error insertion unit 5. In PTP processing, the reception time and the transmission time are used.

The operation display unit 7 includes an input unit that accepts an operation input from a user, and a display unit that displays a parameter setting screen, a test result, and the like. The input unit is configured of, for example, a touch pad, a keyboard, a push button, or the like. The display unit includes a liquid crystal display device or the like.

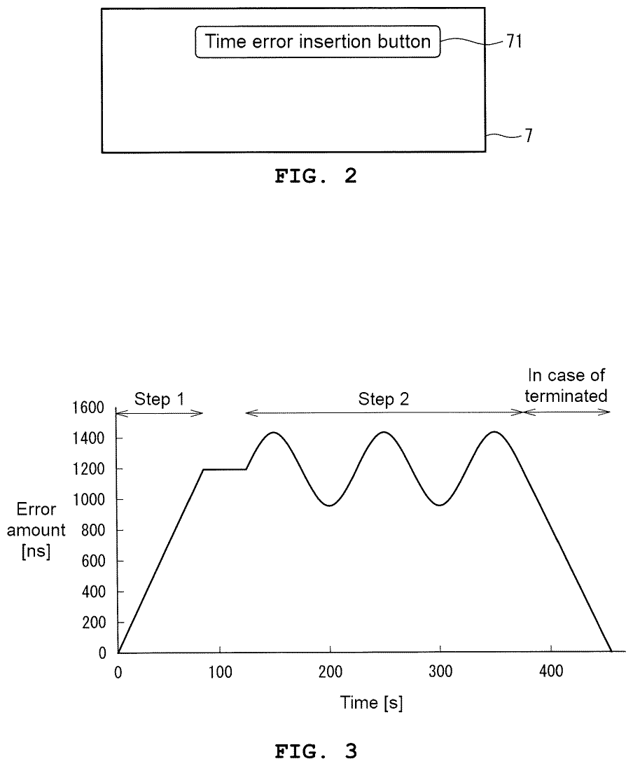

In a case where a time error insertion function is selected by an operation performed on the input unit of the operation display unit 7 by the user, the operation display unit 7, for example, displays a time error insertion button 71 as shown in FIG. 2 on a display unit of the operation display unit 7.

In a case where the time error insertion button 71 is selected by the operation on the input unit of the operation display unit 7 by the user, the operation display unit 7 instructs the transmission time error insertion unit 4 and the reception time error insertion unit 5 to start the PTP error insertion processing.

In a case where an offset-attached error addition test is performed, as shown in FIG. 3, the transmission time error insertion unit 4 and the reception time error insertion unit 5 gradually increase and add the error amount to an offset value as step 1. The same error amount is inserted in the transmission time and the reception time. In FIG. 3, a time point at which step 1 is terminated is a state in which the error amount reaches the offset value.

The transmission time error insertion unit 4 and the reception time error insertion unit 5, for example, increase the error amount by a predetermined error amount for each predetermined period, and increase the error amount to the offset value. The predetermined period is, for example, equal to or less than a control period of the PTP. The predetermined error amount is an error amount that does not cause PTP time synchronization deviation.

In a case where the error amount reaches the offset value, the transmission time error insertion unit 4 and the reception time error insertion unit 5 add the error amount in a sine shape as the error addition test as step 2.

In a case where the error addition test is terminated, the subsequent test can be performed without causing a PTP time synchronization deviation by gradually lowering the error amount from the offset value.

As described above, in the above-described embodiment, in a case where the offset-attached error addition test is performed, the transmission time error insertion unit 4 and the reception time error insertion unit 5 gradually increase and add the error amount to the offset value, and perform the error addition test in a case where the error amount reaches the offset value.

As a result, in a case where the offset-attached error addition test is performed, the error amount is gradually increased and added to the offset value, and the error amount is increased to the offset value. Therefore, a PTP time error insertion function can be realized without causing a PTP time synchronization deviation.

In addition, the transmission time error insertion unit 4 and the reception time error insertion unit 5 increase the error amount by a predetermined error amount for each predetermined period, and increase the error amount to the offset value.

As a result, the error amount is increased by the predetermined error amount for each predetermined period, and the error amount is increased to the offset value. Therefore, a PTP time error insertion function can be realized without causing a PTP time synchronization deviation.

In addition, in a case where the error addition test is terminated, the transmission time error insertion unit 4 and the reception time error insertion unit 5 gradually lower the error amount from the offset value.

As a result, in a case where the error addition test is terminated, the error amount is gradually lowered from the offset value. Therefore, a subsequent test can be performed without causing a PTP time synchronization deviation. For example, a test is possible in which the error addition patterns in ORAN.WG4.CONF.0-R003-v07.00 Sec.3.3.3 Table3.3.3-1 are sequentially performed.

Although an embodiment of the present invention has been disclosed, it will be apparent that modifications may be made by those skilled in the art without departing from the scope of the present invention. All such modifications and equivalents are intended to be included in the following claims.

### DESCRIPTION OF REFERENCE NUMERALS AND SIGNS

1 Measurement Device
2 Ethernet Unit
3 Time Generation Unit
4 Transmission Time Error Insertion Unit
5 Reception Time Error Insertion Unit
6 Packet Time Reception Unit
7 Operation Display Unit
8 O-RU
71 Time Error Insertion Button

What is claimed is:

1. A measurement device that simulates an O-RAN Distributed Unit (O-DU) of an Open-Radio Access Network (O-RAN), the measurement device comprising:
an Ethernet unit that performs transmission and reception of a packet with an O-RAN Radio Unit (O-RU) via a network conforming to a standard of Ethernet;
a time generation unit that generates a base time of the measurement device;
a transmission time error insertion unit that inserts an error in a time generated by the time generation unit, and notifies the Ethernet unit of the time in which the error is inserted; and
a reception time error insertion unit that inserts, in a case where the Ethernet unit receives the packet from the O-RU, an error in a time which is notified by the Ethernet unit and at which the packet is received, wherein
the transmission time error insertion unit and the reception time error insertion unit add an error amount while gradually increasing the error amount to a predetermined offset value in a case where an error addition test is performed by setting an offset value, and perform the error addition test in a case where the error amount reaches the predetermined offset value.

2. The measurement device according to claim 1, wherein
the transmission time error insertion unit and the reception time error insertion unit increase a predetermined error amount for each predetermined period, and increase the error amount to the offset value.

3. The measurement device according to claim 1, wherein
the transmission time error insertion unit and the reception time error insertion unit gradually reduce the error amount from the offset value after the error addition test is terminated.

4. A PTP time error insertion method of a measurement device that simulates an O-DU of an O-RAN, the PTP time error insertion method comprising:
a step of gradually adding and increasing an error amount to an offset value in a case of performing an offset-attached error addition test; and
a step of performing the error addition test in a case where the error amount reaches the offset value.

5. The PTP time error insertion method according to claim 4, wherein,
the step of gradually adding and increasing the error amount to the offset value includes gradually increasing a predetermined error amount for each predetermined period, and increasing the error amount to the offset value.

6. The PTP time error insertion method according to claim 4, wherein
the error amount is gradually reduced from the offset value after the error addition test is terminated.
